(19) United States
(12) Patent Application Publication
(10) Pub. No.: US 2009/0142737 A1
(43) Pub. Date: Jun. 4, 2009

(54) Method and system for developing reading skills

(76) Inventor: Donna J. Breig, Boca Raton, FL (US)

Correspondence Address: MALLOY & MALLOY, P.A., 2800 S.W. Third Avenue, Historic Coral Way, Miami, FL, 33129, US

(21) Appl. No.: 11/998,559

(22) Filed: Nov. 30, 2007

(51) Int. Cl. G09B 17/00; G09B 19/04; G09B 7/00

(52) U.S. Cl. 434/178; 434/167; 434/169

(57) ABSTRACT

A system and method for developing reading skills, the system comprising a processor and a reader interface in communication with one another. The processor is structured to run at least one computer program for facilitating interactive multimedia learning relating to the development of reading skills. The reader interface is structured to present multimedia content including a text-based passage to a reader, and to receive input from the reader. The reader interface is further structured to display animated text, and to permit placement of the animated text in a location that facilitates viewing thereof. The reader interface also comprises audio and graphic aids which correspond to the text-based passage. Additionally, the processor is structured to measure and track at least one reading performance indicator.

### BACKGROUND OF THE INVENTION

1. Field of the Invention

The present application is directed to a method and system for developing reading skills wherein a reader interactively navigates a text-based passage and selectively modifies text display parameters, thus providing an adaptable, easy to use multimedia experience for readers of various reading levels, and particularly for those readers with learning disabilities and/or poor vision. Moreover, the present invention provides a testing and tracking capability for measuring and analyzing progress in the improvement of reading skills.

2. Description of the Related Art

The ability to read is one of the most important life skills utilized by nearly every human being in modern society. Indeed, life in the “information age” requires people to process significant amounts of information, much of which is obtained via reading. Unfortunately, not everyone possesses the natural ability to read with sufficient speed and/or comprehension. There are even some individuals who are significantly challenged with learning to read. For those who read poorly or those who cannot read at all, it can be extremely advantageous to obtain instruction in an effort to develop functional reading skills. Thus, one of the most prevalent objectives of the education field is teaching people of all ages first how to read and then how to improve their reading skills.

Naturally, as the field of reading education has developed significantly over the years, technology has played an ever increasing role. While many current instruction methods conform to more or less the same concepts when it comes to teaching the basics of the alphabet and how to read simple words, there exists more disparity with respect to methods of teaching more complex skills, such as fluid reading of full sentences or paragraphs, as well as comprehension and retention of what has been read.

For example, many of the current methods of teaching reading skills which employ software and computer-based instruction methods are directed primarily to so-called “speed reading,” which aims to improve the speed at which a reader reads, but is not typically associated with improving the quality of other reading skills. Thus, many of the current software-related teaching methods employ exercises geared towards enhancement of the reader's vision and speed, rather than the synthesis and understanding of the content being read. Furthermore, such methods are typically directed to already highly advanced readers.

Moreover, computer programs which claim to help promote the improvement of reading skills typically do noting more than present old-fashioned techniques via computer screen display rather than on paper. This normally involves having the reader read a given passage of text within a certain amount of time—the electronically produced text being presented in the same manner as in a paper workbook—and then having the reader answer questions directed to his or her understanding of what they have just read. Such methods are not much different than traditional methods, particularly in the sense that the content is still presented passively.

It would therefore be highly advantageous for any method and system for developing reading skills to permit the reader to become interactively engaged with the content. Specifically, it would be beneficial for the reader to have the ability to selectively modify text display parameters. It would also be an advantage to employ multimedia content in addition to text, such as graphics and audio, to enhance development of reading skills focusing on the synthesis of the text as a whole and also the meaning of individual words.

It would be particularly beneficial for such a method and system to include a capability of animating text in a manner which can be adjusted by the reader, such that the text is parsed in a quantity and at a rate conducive to that particular reader's learning preference. Moreover, it would also be an advantage to provide the capability of repeating selected words or phrases so that the reader can focus on learning the material at hand before continuing on.

In addition to the mere presentation of animated text, it would also be advantageous to implement auditory aids so that a reader could simultaneously listen to an audio version of the text being read, thereby educating the reader as to proper cadence, inflection, pronunciation, etc. In this regard, it would be a further benefit to enable selective repetition of audio in conjunction with the repetition of text.

Furthermore, there is also a need for incorporating various additional visual aids for such interactive multimedia learning. For example, certain measures such as the adjustment of font size and/or style of animation could assist the reader in keeping focus on the text. It would also be advantageous to employ multimedia graphics, such as pictures or illustrations relating to the passage being read, or certain visual triggers for enhancing comprehension and/or other cognitive processes. It would be a further benefit to allow for adjustment of the location of specific text or other graphics on display.

Further still, such a method and system for developing reading skills should preferably incorporate features which give special consideration to readers with learning or behavioral disabilities, such as recovering accident victims or sufferers of ADHD (Attention-Deficit/Hyperactivity Disorder), EI (Excessive Impulsivity), etc. Accordingly, it would be beneficial ensure that readers are guided through the learning process in a controlled manner. For example, enablement of only essential “buttons” for navigating a passage via computer interface could encourage excessively impulsive (EI) readers, who are predisposed to selecting random buttons or repeatedly selecting the same button, to control themselves in order to proceed. It would also be advantageous to allow the reader to pause and/or mark their place, such as when an ADHD reader becomes inattentive and unfocused, so that they can later resume where they left off.

Another shortcoming of current methods and systems in the field of reading education is the inability to accommodate people with vision problems. Some common conditions affecting eyesight include cataracts, macular degeneration, tunnel vision, amblyopia (lazy eye), myopia (nearsightedness), and hyperopia (farsightedness). Paralysis can also affect a person's ability to read, as movement of the head or eyes may be impaired. As such, there is a need for locating the text or portion thereof in a manner which the reader can comfortably identify and concentrate on, even if the reader has a disability. Further, in the case of bifocal or progressive lens wearers, there is a need for displaying text in a manner which minimizes or eliminates head movement as a compensation for the lens shortcomings. For example, it would be beneficial to locate the text on a portion of a computer screen where bifocal wearers would not have to strain their neck to see the top of the screen. Similarly, it would be beneficial to locate the text where progressive lens wearers would not have to constantly adjust their entire head, so as to eliminate dizziness or so called “swimming text” in the peripheral field of sight.

In light of the foregoing, it would also be advantageous for such a method and system for developing reading skills to provide a testing and tracking capability for measuring and analyzing progress in the improvement of reading skills.

### SUMMARY OF THE INVENTION

The present application is directed to a method and system for developing reading skills wherein a reader interactively navigates a text-based passage and selectively modifies text display parameters, thus providing an adaptable, easy to use multimedia experience for readers of various reading levels, and particularly for those readers with learning disabilities and/or poor vision. Moreover, the present invention provides a testing and tracking capability for measuring and analyzing progress in the improvement of reading skills.

The inventive method and system may assume a variety of physical and logical configurations, including a variety of computers under a number of different operating systems and network configurations. In one embodiment, the system comprises a processor and a reader interface. The processor is structured to run at least one computer program for facilitating interactive multimedia learning relating to the development of reading skills. The reader interface is structured to present multimedia content to a reader, and further structured to receive input from the reader.

In at least one embodiment, the processor and reader interface are disposed in a communicating relation. In one such embodiment, the processor and the reader interface are physically linked in direct communication. The processor may comprise a desktop computer, a mainframe computer, Internet server, or other computing device capable of hosting and handling communication and running multimedia interactive content. The reader interface may comprise one or more input/output devices including, but not limited to, keypads, mice, displays, speakers, headphones, etc. In at least one further embodiment, the reader interface and/or the processor may be embodied in a laptop or notebook computer, a video game console, a personal digital assistant, a cell phone, or other handheld communication and/or computing device.

In a further embodiment, the processor is disposed in a communicating relation with a remote computer via a network. The remote computer can be any device capable of storing multimedia content which is accessible via the network. In one embodiment, the network comprises the Internet. In another embodiment, the reader interface is also disposed in communicating relation with the remote computer via a direct link with the processor.

The reader interface comprises a number of functions and features for developing the reader's reading skills. In accordance with at least one embodiment, the reader interface comprises a login capability structured to permit a reader to securely access the reader interface. For example, in one embodiment, the login feature requires the reader to enter a matching username and a password to gain secure access to the reader interface.

The reader interface additionally comprises a passage selection capability structured to permit the reader to select from a plurality of text-based passages. In one embodiment, each of the plurality of text-based passages is identified according to reading skill level. For example, the text based passage may be selected according to school grade reading level, including sub-levels within each school grade. In addition, the passage selection capability is also structured to permit the reader to select a list of words, such as vocabulary words, and/or a list of hard to sound words, such as non-phonetic “sight words,” for specific emphasis. In at least one embodiment, the list of words is presented to the reader automatically as background material for the text-based passage. In a further embodiment, the list of words is presented in a puzzle type format to further prepare the reader for reading the selected text-based passage.

The reader interface also comprises a copying capability structured to permit selective copying of remote multimedia content for use. In at least one embodiment, the copying capability is structured to permit selective copying of text-based passages which are stored externally to both the processor the reader interface. In one such embodiment, the copy and paste capability is structured to permit copying of a text-based passage stored on a remote computer in communication with the reader interface and the processor via the Internet.

The reader interface further comprises a content display capability structured to display multimedia content. In at least one embodiment, the content display capability comprises a text animation capability structured to dynamically display at least a portion of a text-based passage as animated text. In at least one further embodiment, the content display capability also includes a graphic aid capability structured to display pictures, photographs, video, etc. In an alternate embodiment, the content display capability comprises a text animation capability, but not a graphic aid capability.

In one embodiment, the text animation capability displays one word at a time such that each new word is displayed as the animated text is advanced. In an alternate embodiment, the text animation capability displays a plurality of words at a time such that multiple new words are displayed as the animated text is advanced. In yet another embodiment, the text animation capability is structured to display subsequent portions of the text-based passage proceeding from left to right so that the reader sees only the newly presented portion of text. In an alternate embodiment, the text animation capability is structured to progressively add words and/or punctuation to the display of the portion of the text-based passage such that one or more phrases or sentences are created as the reading advances.

The reader interface further comprises visual aid capabilities structured to assist persons with disabilities, such as those who are vision challenged, in reading the animated text. Specifically, in at least one embodiment, the reader interface is further structured to permit adjustment of the animated text font size. In addition, the reader interface comprises a text locating capability structured to permit placement of the animated text in a location that allows a vision challenged reader to see the animated text more clearly and comfortably. In one embodiment, the text locating capability is structured to optimize the location of the animated text for a wearer of bifocal lenses. In another embodiment, the text locating capability is structured to optimize the location of the animated text for a wearer of progressive lenses. In yet another embodiment, the text locating capability is structured to optimize the location of the animated text for a reader with tunnel vision, cataracts, macular degeneration, or amblyopia. In still another embodiment, the location can be optimized for paralyzed readers. In at least one embodiment, the text locating capability is structured to permit the location of the animated text to be selected from a plurality of available locations. In at least one other embodiment, the text locating capability is structured to permit manual adjustment of the location of the animated text.

The reader interface further comprises a start button feature which initiates an interactive multimedia learning session for developing reading skills.

The reader interface additionally comprises a number of other features and capabilities with which permit the reader to interact with the multimedia content. For example, in at least one embodiment, the reader interface comprises an audio aid structured to correspond to the text-based passage. Specifically, the audio aid produces sounds that enable the reader to hear the proper pronunciation of one or more words and/or the proper inflection of punctuation of one or more sentences. In one embodiment, an audio aid is structured to pronounce a selected word. In another embodiment an audio aid is structured to pronounce a selected sentence with proper inflection of punctuation. In an alternate embodiment, the audio aid is structured to play automatically in coordination with the animation of text.

The reader interface is further structured to adjust the temporal manner in which the multimedia content is presented. Specifically, the reader interface comprises a speed adjustment capability which is structured to permit adjustment of automatically advanced animated text. In one embodiment, the speed adjustment capability permits selectable adjustment of the automatically advanced animated text to slower or faster rates, as with a speed slowing capability and a speed increasing capability. The reader interface further comprises a pause capability structured to permit the selective and temporary halting of the automatic advancement of the animated text. The pause capability is also structured to permit resuming of the automatic advancement of the animated text. In another embodiment, the advancement of the animated text automatically pauses on the first word of a page of the text-based passage. In yet another embodiment, the reader interface additionally comprises a manual advancement capability. In one embodiment, the manual advancement capability permits selectable navigation to a previous and/or a next portion(s) of the text-based passage, as with a backward manual advancement capability, and a forward manual advancement capability.

The reader interface additionally comprises a repeat capability structured to repeat a presented animated text portion of the text-based passage. In one embodiment, a repeat word capability permits selectable repetition of one or more words. In another embodiment, a repeat sentence capability permits selectable repetition of a sentence. In at least one embodiment, the repeated text is simultaneously played aloud by the audio aid.

The reader interface additionally comprises a marking capability structured to mark a place within the text-based passage so that a reader can exit a session and later return to the marked place to continue the session. As such, the reader interface also comprises an exit capability structured to permit the reader to exit a session.

In at least one embodiment, the various navigational features can be utilized in guiding the reader to read the selected passage several times in different ways, emphasizing different types of multimedia and different types of interactivity. The particular aspects exercised in each of the different readings build upon one another to further facilitate the improvement of the reader's reading skills. For example, in one embodiment, the reader is first directed to manually the advance the animated text from one portion of the text-based passage to another. Next, the reader is directed to re-read the text-based passage as it is automatically advanced, without the use of any audio aids. Thereafter, the reader is directed to once again to re-read the passage as it is automatically advanced, but this time, in combination with an audio aid.

The reader interface is further structured to guide the reader through post-reading diagnostics, such as, but not limited to, multiple choice tests, which facilitate measurement of one or more reading performance indicators. By way of example, the various reading performance indicators may include, but are not limited to, vocabulary retention, reading comprehension, etc. In at least one embodiment, the reader interface pronounces multiple choice questions aloud so that the reader can focus on answering the question, rather than reading the question. The processor is structured to track the reading performance indicators to facilitate analysis of reading development progress. The reader interface is further structured to display a multimedia representation of the reader's progress as measured by at least one reading performance indicator.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic view of one embodiment of a system in accordance with the present invention.

FIG. 2 is a schematic view of one embodiment of the reader interface of FIG. 1.

FIG. 3 is a schematic view of an alternate embodiment of the content display capability of FIG. 2.

FIG. 4 is a schematic view of one embodiment of animated text in accordance with the present invention.

FIG. 5 is a schematic view of another embodiment of animated text in accordance with the present invention.

FIG. 6 is a flowchart of one aspect of a method for developing reading skills according to the present invention.

FIG. 7 is a flowchart of another aspect of a method for developing reading skills according to the present invention.

FIG. 8 is a flowchart of yet another aspect of a method for developing reading skills according to the present invention.

Like reference numerals refer to like parts throughout the several views of the drawings.

### DETAILED DESCRIPTION OF THE PREFERRED EMBODIMENT

As shown in the accompanying figures, the present application is directed to a method and system for developing reading skills wherein a reader interactively navigates a text-based passage and selectively modifies text display parameters, thus providing an adaptable, easy to use multimedia experience for readers of various reading levels, and particularly for those readers with learning disabilities and/or poor vision. Moreover, the present invention provides a testing and tracking capability for measuring and analyzing progress in the improvement of reading skills.

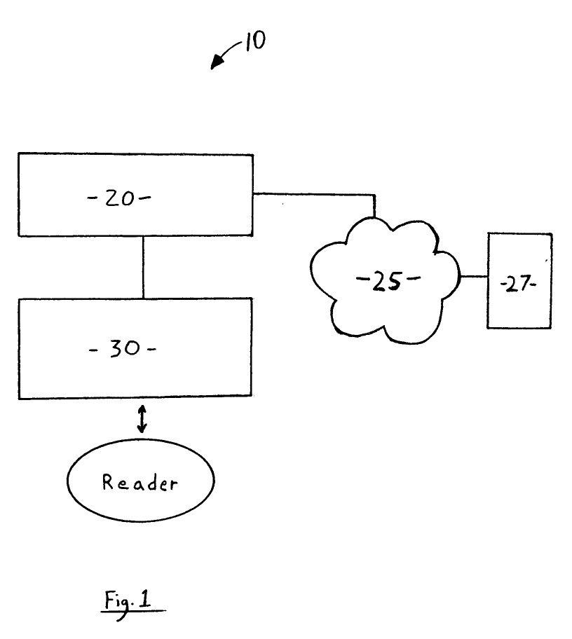

FIG. 1 depicts a schematic of one embodiment of the system of the present invention, generally indicated as 10. The system 10 may assume a variety of physical and logical configurations, including a variety of computers under a number of different operating systems and network configurations. In this embodiment, the system 10 comprises a processor 20 and a reader interface 30. The processor 20 is structured to run at least one computer program for facilitating interactive multimedia learning relating to the development of reading skills. The reader interface 30 is structured to present multimedia content to a reader and further structured to receive input from the reader.

In further accordance with FIG. 1, the processor 20 and reader interface 30 are disposed in a communicating relation. In this embodiment, the processor 20 and the reader interface 30 are physically linked in direct communication. The processor 20 may comprise a desktop computer, a mainframe computer, Internet server, or other computing device capable of hosting and handling communication and running multimedia interactive content. The reader interface 30 may comprise one or more input/output devices including, but not limited to, keypads, mice, displays, speakers, headphones, etc. In at least one further embodiment, the reader interface 30 and/or the processor 20 may be embodied in a laptop or notebook computer, a video game console, a personal digital assistant, a cell phone, or other handheld communication and/or computing device.

In at least one further embodiment, the processor 20 is further disposed in a communicating relation with a remote computer 27 via a network 25. The remote computer 27 can be any device capable of storing multimedia content which is accessible via the network 25. The reader interface 30 is also disposed in communicating relation with the remote computer 27 via the direct link with the processor 20. In one embodiment, the network 25 comprises the Internet. In another embodiment, the network 25 comprises a local area network.

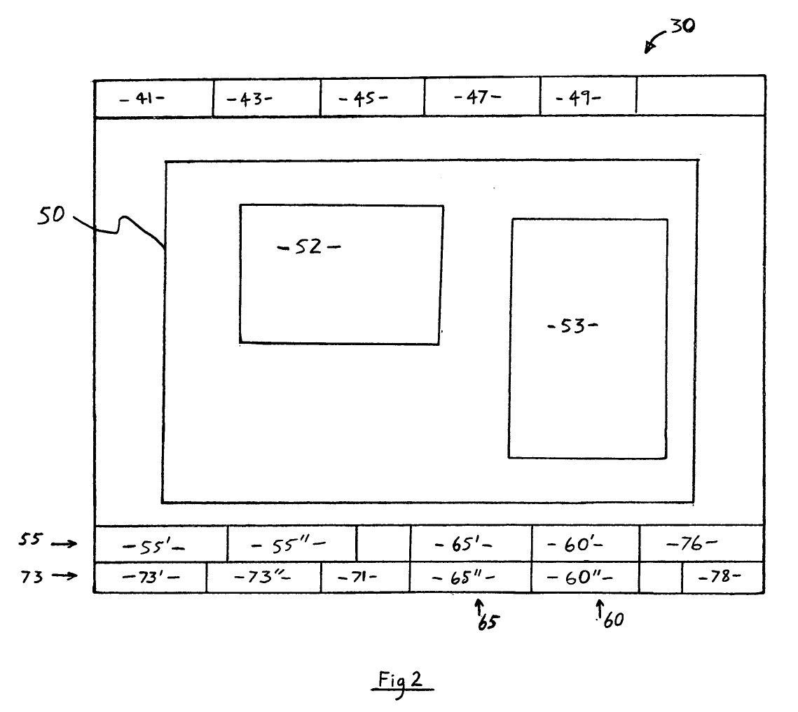

With reference now to FIG. 2, the reader interface 30 comprises a number of functions and features for developing the reader's reading skills. In accordance with the embodiment shown, the reader interface 30 comprises a login capability 41 structured to permit a reader to securely access the reader interface 30. In one particular embodiment, the login feature 41 requires the reader to enter a matching username and a password to gain secure access to the reader interface 30.

The reader interface 30 additionally comprises a passage selection capability 43 structured to permit the reader to select from a plurality of text-based passages. In one embodiment, each of the plurality of text-based passages is identified according to reading skill level. For example, the text based passage may be selected according to school grade reading level, including sub-levels within each school grade. In addition, the passage selection capability is also structured to permit the reader to select a list of words, such as vocabulary words, and/or a list of hard to sound words, such as non-phonetic “sight words,” for specific emphasis. In at least one embodiment, the list of words is presented to the reader automatically as background material for the text-based passage. In a further embodiment, the list of words is presented in a puzzle type format to further prepare the reader for reading the selected text-based passage.

The reader interface 30 also comprises a copying capability 45 structured to permit selective copying of remote multimedia content for use via the reader interface 30. In at least one embodiment, the copying capability 45 is structured to permit selective copying of text-based passages which are stored externally to both the processor 20 and the reader interface 30. In one such embodiment, the copy and paste capability 45 is structured to permit copying of a text-based passage stored on the remote computer 27 in communication with the reader interface 30 and the processor 20 via the Internet.

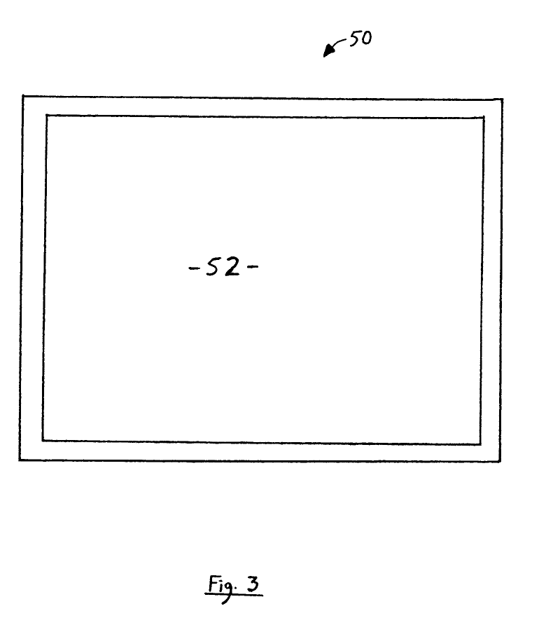

The reader interface 30 further comprises a content display capability 50 structured to display multimedia content. In at least one embodiment, the content display capability 50 comprises a text animation capability 52, structured to dynamically display at least a portion of a text-based passage as animated text. As used herein, animated text is defined as text which is displayed in such a manner that the visual representation of the text changes as a function of time. In at least one further embodiment, the content display capability 50 also includes a graphic aid capability 53 structured to display pictures, photographs, video, etc. The graphic aid capability 53 provides the reader with visual context for the passage being read. In an alternate embodiment, the content display capability 50 comprises a text animation capability 52, but not a graphic aid capability 53, as depicted in FIG. 3.

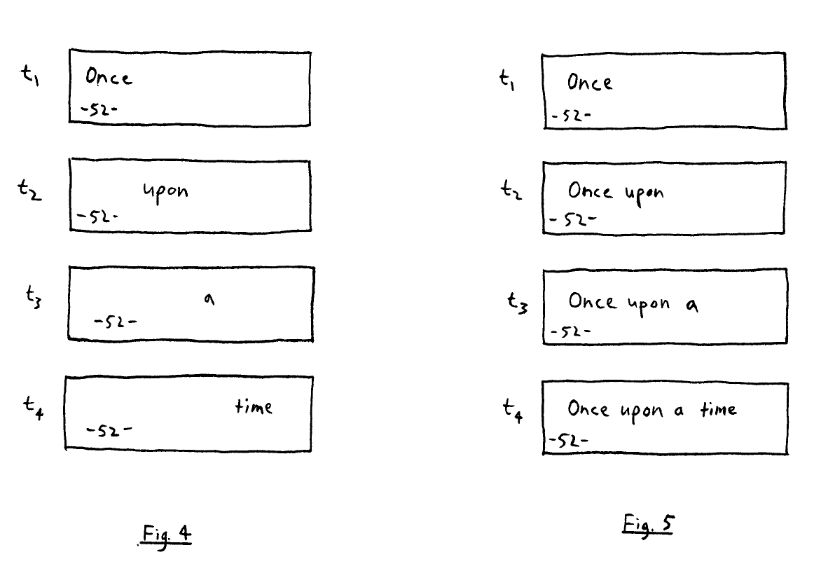

In one embodiment, the animation capability 52 displays one word at a time such that each new word is displayed as the animated text is advanced. In an alternate embodiment, the text animation capability 52 displays a plurality of words at a time such that multiple new words are displayed as the animated text is advanced. In one such embodiment, the text animation capability 52 displays one sentence at a time. In a further embodiment, the text animation capability 52 displays one page at a time. In yet another embodiment, the text animation capability 52 is structured to display subsequent portions of the text-based passage proceeding from left to right so that the reader sees only the newly presented portion of text, as illustrated in FIG. 4. In this embodiment, as time (t) progresses (illustrated as t₁ through t₄), each word appears alone in a relative location within the text animation capability 52. In an alternate embodiment, depicted in FIG. 5, the text animation capability 52 is structured to progressively add words and/or punctuation to the display of the portion of the text-based passage such that one or more phrases or sentences are created as the reading advances.

Returning to FIG. 2, the reader interface 30 further comprises visual aid capabilities structured to assist persons with disabilities, such as those who are vision challenged, in reading the animated text. Specifically, in at least one embodiment, the reader interface 30 is further structured to permit adjustment of the animated text font size. In addition, the reader interface 30 comprises a text locating capability 47 structured to permit placement of the animated text in a location that allows a vision challenged reader to see the animated text more clearly and comfortably. In one embodiment, the text locating capability 47 is structured to optimize the location of the animated text for a wearer of bifocal lenses. In another embodiment, the text locating capability 47 is structured to optimize the location of the animated text for a wearer of progressive lenses. In yet another embodiment, the text locating capability 47 is structured to optimize the location of the animated text for a reader with tunnel vision, cataracts, macular degeneration, or amblyopia. In still another embodiment, the location can be optimized for paralyzed readers. In at least one embodiment, the text locating capability 47 is structured to permit the location of the animated text to be selected from a plurality of available locations. In at least one other embodiment, the text locating capability 47 is structured to permit manual adjustment of the location of the animated text.

The reader interface 30 further comprises a start button feature 49 which initiates an interactive multimedia learning session for developing reading skills.

As discussed further herein, the reader interface 30 additionally comprises a number of other features and capabilities with which the reader interacts with the multimedia content. For example, the reader interface 30 comprises an audio aid 60 structured to correspond to the text-based passage. Specifically, the audio aid 60 produces sounds that enable the reader to hear the proper pronunciation of one or more words and/or the proper inflection of punctuation of one or more sentences. In one embodiment, an audio aid 60′ is structured to pronounce a selected word. In another embodiment an audio aid 60″ is structured to pronounce a selected sentence with proper inflection of punctuation. In an alternate embodiment, the audio aid 60 is structured to play automatically in coordination with the animation of text.

The reader interface 30 is further structured to adjust the temporal manner in which the multimedia content is presented. Specifically, the reader interface 30 comprises a speed adjustment capability 55 which is structured to permit adjustment of automatically advanced animated text. In at least one embodiment, the text animation capability 52 is structured to display the portion of the text-based passage for a predetermined amount of time such that another portion of the text-based passage can be displayed thereafter. For example, in this embodiment, the speed adjustment capability 55 permits selectable adjustment of the automatically advanced animated text to slower or faster rates, as with a speed slowing capability 55′, and a speed increasing capability 55″. The reader interface 30 further comprises a pause capability 71 structured to permit the selective and temporary halting of the automatic advancement of the animated text. The pause capability 71 is also structured to permit resuming of the automatic advancement of the animated text. In another embodiment, the advancement of the animated text automatically pauses on the first word of a page of the text-based passage. In such an embodiment, this pause allows the reader to mentally prepare for reading each succeeding page of words, phrases, sentences, etc.

The reader interface 30 additionally comprises a manual advancement capability 73. In the embodiment of FIG. 2, the manual advancement capability 73 permits selectable navigation to a previous and/or a next portion(s) of the text-based passage, as with a backward manual advancement capability 73′, and a forward manual advancement capability 73″. In at least one embodiment, the manual advancement capability 73 may also be used in conjunction with the pause capability 71.

The reader interface 30 additionally comprises a repeat capability 65 structured to repeat a presented animated text portion of the text-based passage. In one embodiment, a repeat word capability 65′ permits selectable repetition of one or more words. In another embodiment, a repeat sentence capability 65″ permits selectable repetition of a sentence. In at least one embodiment, the repeated text is simultaneously played by the audio aid 60.

The reader interface 30 additionally comprises a marking capability 76 structured to mark a place within the text-based passage so that a reader can exit a session and later return to the marked place to continue the session. As such, the reader interface 30 also comprises an exit capability 78 structured to permit the reader to exit a session.

The reader interface 30 is further structured to guide the reader through post-reading diagnostics, such as, but not limited to, multiple choice tests, which facilitate measurement of one or more reading performance indicators. By way of example, the various reading performance indicators may include, but are not limited to, vocabulary retention, reading comprehension, etc. In at least one embodiment, the reading performance indicators are objectively measured by the reader's answers to the multiple choice questions. In at least one embodiment, the reader interface 30 pronounces the multiple choice questions aloud so that the reader can focus on answering the question, rather than reading the question.

The processor 20 is structured to track the reading performance indicators to facilitate analysis of reading development progress. The reader interface 30 is further structured to display a multimedia representation of the reader's progress as measured by at least one reading performance indicator. For example, a graph or chart may display a reader's test results for a number of passages.

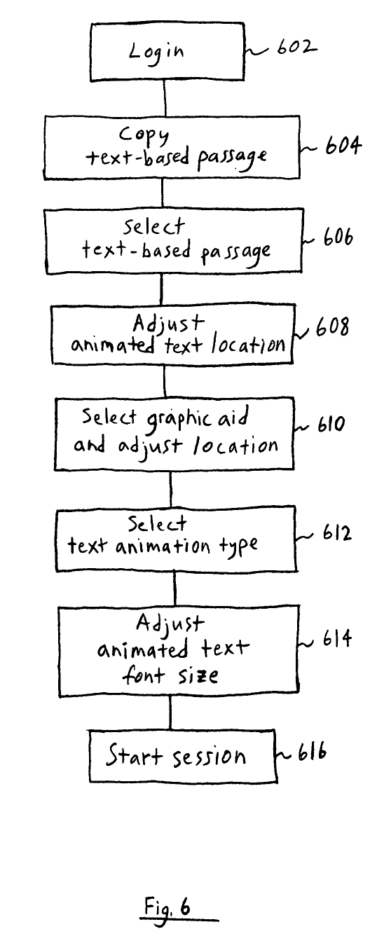

Turning now to the flow chart of FIG. 6, one embodiment of setting up a reading skills development session is shown as a flow chart. Block 602 depicts logging in to the reader interface 30. In at least one embodiment, logging in requires the matching of a username and password. For example, in one embodiment, logging in requires entering of a reader's last name as their username and entering of their date of birth as their password.

Continuing with this embodiment, the reader selectively copies a text-based passage stored remotely with respect to both the processor 20 and the reader interface 30, as at 604. In at least one embodiment, at least one text-based passage is copied from a server 27 in communication with the reader interface 30 and the processor 20 via the Internet.

Next, a particular text-based passage is selected for the reading skills development session, as at 606. In at least one embodiment, the selected text-based passage is selected from a plurality of text-based passages. In a one embodiment, the plurality of text-based passages includes the copied passage of block 604. In a further embodiment, the text-based passages are identified according to reading skill level. For example, the text-based passage may be selected according to school grade reading level.

Once the subject matter has been selected, the various display parameters are then selected and/or adjusted. In this embodiment, Block 608 depicts adjustment of the location of animated text. The animated text can also be placed to facilitate viewing by a vision challenged reader. In one embodiment, the animated text is situated in a location optimized for a wearer of bifocal lenses. For example, in at least one embodiment, the animated text is located in the bottom third of the content display 50. In another embodiment, the animated text is located in a location optimized for a wearer of progressive lenses. For example, in at least one embodiment, the animated text is located substantially in the center of the content display 50, and extends horizontally within a zone smaller than the peripheral field of view. In at least one embodiment, the location of the animated text is selected from a plurality of available locations. In at least one other embodiment, the location of the animated text is manually adjusted. In a further embodiment, the location can be interactively optimized for readers with limited fields of vision, such as readers with cataracts or paralyzed readers.

Block 610 depicts the selection of a graphic aid 53. The graphic aid facilitates the reader in interpreting the text-based passage. In at least one embodiment, the location of the graphic aid 53 is adjusted in coordination with the location of the animated text. In a further embodiment, the size of the graphic aid 53 is adjusted.

Block 612 illustrates the selection of the type of text animation. In at least one embodiment, the reader selects from a plurality of text animation types. For example, in one embodiment, one type of text animation displays one word at a time such that each new word is displayed as the text is advanced. In another embodiment, another type of text animation displays a plurality of words such that multiple new words are displayed as the text is advanced. In one such embodiment, the text animation displays one sentence at a time. In a further embodiment, another type of text animation displays one page at a time. In yet another embodiment, one type of text animation displays subsequent portions of the text-based passage proceeding from left to right so that the reader sees only the newly presented portion of text. In an alternate embodiment, another type of text animation progressively adds words and/or punctuation to the display of the portion of the text-based passage such that one or more phrases or sentences are created as the reading advances.

Next, the size of the animated text font is adjusted, as at 614. Thereafter, the reader starts the reading skills development session, as at 616.

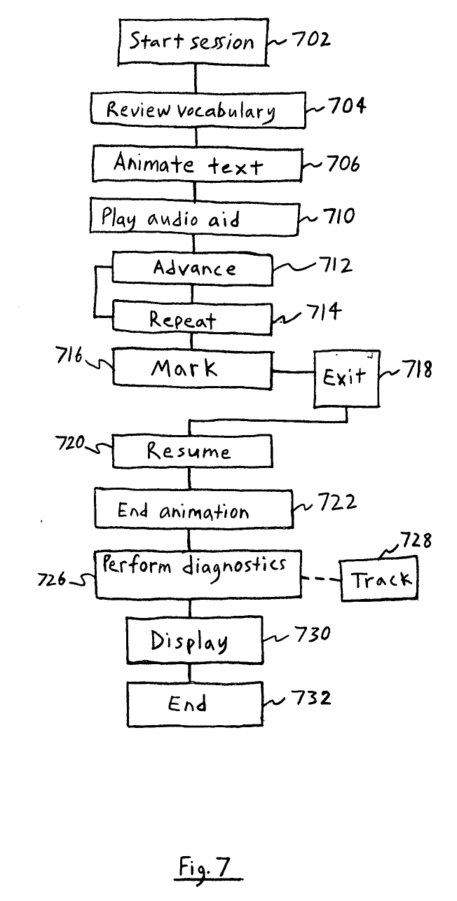

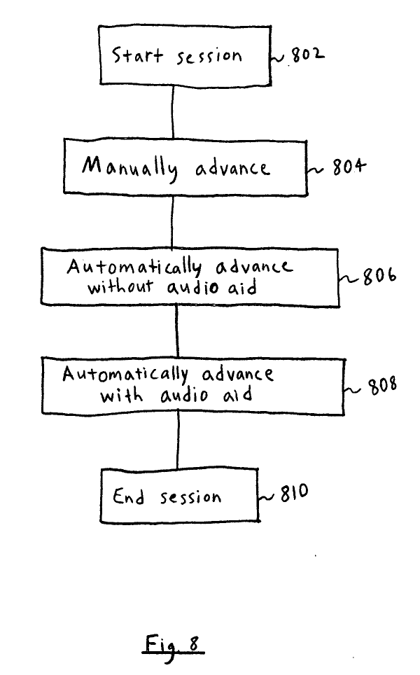

With reference now to the flow chart of FIG. 7, one embodiment of conducting a reading skills development session is illustrated. Block 702 depicts starting the session. In this embodiment, the reader first reviews vocabulary words, as at 704, before proceeding to read the selected text-based passage. In another embodiment, the reader may review a list of hard to sound words, such as non-phonetic “sight words,” for specific emphasis. In a further embodiment, the list of words is presented in a puzzle type format to further prepare the reader for reading the text-based passage.

Block 706 depicts beginning the animation of the text of the text-based passage. Block 710 depicts playing an audio aid 60 to complement the reading of the animated text by the reader. The audio aid 60 produces sounds that enable the reader to hear the proper pronunciation of one or more words and/or the proper inflection of punctuation of one or more sentences. In one embodiment, the audio aid 60′ is structured to pronounce a selected word. In another embodiment the audio aid 60″ is structured to pronounce a selected sentence with proper inflection of punctuation. In an alternate embodiment, the audio aid 60 is structured to play automatically in coordination with the animation of text.

Block 712 illustrates the advancement of the animated text from one portion of the text-based passage to another. In at least one embodiment, the advancement of the animated text is performed manually, permitting selective navigation to a next portion(s) of the text-based passage. In another embodiment, the manual advancement of animated text also permits selective navigation to a previous portion of the text-based passage. In another embodiment the animated text is advanced automatically. In a further embodiment, a speed of advancement can be adjusted. In one such embodiment, the speed of advancement may also be set to correspond to a reading skill level.

Block 714 shows the repeating of the display of already presented animated text. In one embodiment, at least one word of the animated text is selectively repeated. For example, when a reader desires to review a word that was previously animated, the reader can invoke the repeat capability 65′. In another embodiment, a sentence is selectively repeated. In at least one embodiment, the repeated text is simultaneously played by the audio aid 60.

The embodiment of FIG. 7 also depicts marking a place within the text-based passage so that a reader can exit a session, as at 718, and later return to the marked place to resume the session, as at 720.

When the animation of text reaches the end of the text-based passage, the animation of text is ended, as at 722. Next, the reader is guided through post-reading diagnostics, such as, but not limited to, multiple choice tests, which permit measurement of one or more reading performance indicators, as at 726. By way of example, the various reading performance indicators may include, but are not limited to, vocabulary retention, reading comprehension, etc. The reading performance indicators are tracked to facilitate analysis of progress, as at 728. In conjunction with the post-reading diagnostics, one or more of the various reading performance indicators are displayed as a multimedia representation, as at 730. Thereafter, the session is ended, as at 732.

With reference now to the flow chart of FIG. 8, another embodiment of conducting a reading skills development session is illustrated. In this embodiment, the reader is guided to read the selected passage several times in different ways, utilizing different types of multimedia and different types of interactivity. The particular aspects exercised in each of these different readings build upon one another to further facilitate the improvement of the reader's reading skills.

Block 802 depicts starting the session. At Block 804, the reader is directed to manually the advance the animated text from one portion of the text-based passage to another. In at least one further embodiment, the reader can additionally invoke various other functions and features. For example, the reader may select a repeat 65 of the display of animated text or play an audio aid 60 in conjunction with the display of animated text.

Next, the reader is directed to re-read the text-based passage as it is automatically advanced, as at 806. In this particular step, the animated text is advanced without any audio aid 60. However, in at least one embodiment, the reader can adjust the display speed 55 of the animated text.

Next, the reader is directed to once again to re-read the passage as it is automatically advanced, as at 808. This time, the animated text is advanced in combination with an audio aid 60.

Thereafter, the session is ended, as at 810. Of course, it should be noted that, in addition to the embodiment of FIG. 8, it is within the scope and intent of the present invention that the various functions and features described herein may be utilized in other combinations and/or sequences to facilitate the improvement of the reader's reading skills.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of developing reading skills, comprising:
selecting a text-based passage;
displaying a portion of the text-based passage as animated text; and
advancing the display of animated text through the text-based passage to facilitate development of reading skills.

2. A method as recited in claim 1 further comprising playing an audio aid wherein the audio aid corresponds to the animated text.

3. A method as recited in claim 2 wherein the playing of the audio aid further comprises correctly pronouncing at least one word of the animated text.

4. A method as recited in claim 2 wherein the playing of the audio aid further comprises correctly inflecting at least one sentence of the animated text.

5. A method as recited in claim 2 further comprising playing the audio aid simultaneously with the display of the animated text.

6. A method as recited in claim 2 further comprising:
manually advancing the display of the animated text through the entire text-based passage;
automatically advancing the display of the animated text through the entire text-based passage without playing the audio aid; and
automatically advancing the display of the animated text through the entire text-based passage while playing the audio aid.

7. A method as recited in claim 1 further comprising displaying a graphic aid wherein the graphic aid corresponds to the text-based passage.

8. A method as recited in claim 1 wherein the selecting the text-based passage comprises selecting from a list of text-based passages according to reading skill level.

9. A method as recited in claim 1 wherein the displaying of the animated text comprises displaying one word at a time.

10. A method as recited in claim 1 wherein the displaying of the animated text comprises displaying a plurality of words at a time.

11. A method as recited in claim 10 wherein the displaying of the animated text comprises displaying one sentence at a time.

12. A method as recited in claim 10 wherein the displaying of the animated text comprises displaying one page at a time.

13. A method as recited in claim 12 further comprising automatically pausing an automatically advanced display of animated text on the first word of each page of the text-based passage.

14. A method as recited in claim 1 wherein the displaying of the animated text comprises showing subsequent portions of the text-based passage proceeding from left to right so that a reader only sees each said subsequent portion of the text-based passage.

15. A method as recited in claim 1 wherein the displaying of the animated text comprises progressively adding succeeding portions of the text-based passage to previously displayed portions of the text-based passage.

16. A method as recited in claim 1 further comprising obtaining the text-based passage from a remote source.

17. A method as recited in claim 1 further comprising selectively repeating the display of at least one word of the animated text.

18. A method as recited in claim 1 further comprising marking a place in the text-based passage that can be returned to.

19. A method as recited in claim 1 further comprising:
measuring at least one reading performance indicator; and
tracking the at least one reading performance indicator.

20. A method as recited in claim 19 further comprising displaying a progress chart of the tracked at least one reading performance indicator.

21. A method of developing reading skills, comprising:
displaying a portion of a text-based passage as animated text;
advancing the display of animated text through the text-based passage to facilitate development of reading skills;
placing the animated text in a location that facilitates viewing of the animated text by a reader having a disability;
optimizing the placing of the animated text based on the reader's disability; and
playing an audio aid wherein the audio aid corresponds to the animated text.

22. A method as recited in claim 21 comprising placing the animated text in a bottom third of a content display.

23. A method as recited in claim 21 comprising placing the animated text in a center of a content display and limiting the width of displayed animated text to within a zone smaller than a peripheral field of view.

24. A system for developing reading skills, comprising:
at least one processor structured to run at least one computer program for facilitating interactive multimedia learning relating to the development of reading skills;
a reader interface in communication with said at least one processor structured to present multimedia content including a text-based passage to a reader, and further structured to receive input from the reader;
said reader interface further structured to display animated text;
said reader interface further structured to permit placement of said animated text in a location that facilitates viewing thereof;
said reader interface further comprising an audio aid structured to correspond to said animated text;
said processor further structured to measure at least one reading performance indicator; and
said processor further structured to track said at least one reading performance indicator.

25. A system as recited in claim 24 wherein said reader interface further comprises a graphic aid structured to correspond to said text-based passage.

26. A system as recited in claim 24 wherein said reader interface is further structured to permit manual advancing of said display of animated text.

27. A system as recited in claim 24 wherein said reader interface is further structured to permit automatic advancing of said display of animated text.

28. A system as recited in claim 27 wherein said reader interface is further structured to permit pausing said automatic advancing of said display of animated text.

29. A system as recited in claim 24 wherein said reader interface is further structured to permit selective repeating of a display of at least one word of said animated text.

30. A system as recited in claim 24 wherein said reader interface is further structured to permit selective repeating of a display of at least one sentence of said animated text.

31. A system as recited in claim 24 wherein said audio aid is further structured to permit playing of a correct pronunciation of at least one word of said animated text.

32. A system as recited in claim 24 wherein said audio aid is further structured to permit playing of a correct inflection of punctuation of at least one sentence of said animated text.

33. A system as recited in claim 24 wherein said reader interface is further structured to permit placement of said animated text in a location optimized for viewing by a reader having a disability.

34. A system as recited in claim 33 wherein said reader interface is further structured to permit placement of said animated text in a bottom third of a content display.

35. A system as recited in claim 33 wherein said reader interface is further structured to permit placement of said animated text in a center of a content display and to limit the width of displayed animated text to within a zone smaller than a peripheral field of view.

36. A system as recited in claim 24 wherein said reader interface is further structured to pronounce at least one multiple choice question aloud, said multiple choice question pertaining to said at least one reading performance indicator.

37. A system as recited in claim 24 wherein said reader interface is further structured to display a progress chart of said tracked at least one reading performance indicator.
